(19) United States
(12) Patent Application Publication
(10) Pub. No.: US 2018/0250628 A1
(43) Pub. Date: Sep. 6, 2018

(54) SORBENT INJECTION SYSTEM AND METHOD FOR TREATING FLUE GASES

(71) Applicant: Mobotec UK Ltd, Castle Donington (DE)

(72) Inventors: Michael B Klump, Atlanta, GA (US); Guisu Liu, Naperville, IL (US); Baiyun Gong, Naperville, IL (US); Alan Chadwick, West Hallam (GB); Craig Paquette, Mt. Pleasant, SC (US); Joseph J Aletto, Jupiter, FL (US); Brian C Smith, Centerville, OH (US)

(21) Appl. No.: 15/756,528

(22) PCT Filed: Aug. 31, 2016
(86) PCT No.: PCT/GB2016/052697

§ 371 Date: Feb. 28, 2018

Related U.S. Application Data
(60) Provisional application No. 62/212,190, filed on Aug. 31, 2015.

(51) Int. Cl. B01D 53/34; B01D 53/50; B01D 53/64; B01D 53/68; B01D 53/83; F23J 15/00

(52) U.S. Cl. CPC B01D 53/346; B01D 2259/128; B01D 53/64; B01D 53/685; B01D 53/83; F23J 15/003; F23J 2219/50; F23J 2219/60; F23J 2219/40; B01D 2251/304; B01D 2251/306; B01D 2251/402; B01D 2251/404; B01D 2251/602; B01D 2251/604; B01D 2251/606; B01D 2257/2022; B01D 2251/2062; B01D 2257/2025; B01D 2257/2042; B01D 2257/2045; B01D 2257/2047; B01D 2257/302; B01D 2257/602; B01D 2258/0283; B01D 2259/126; B01D 53/508

(57) ABSTRACT

The present application provides a method of treating flue gas in a duct with an injection system, the flue gas comprising an acid gas and/or one or more metal components, the injection system comprising at least one injection nozzle in communication with an air supply and a supply of sorbent; wherein the method comprises supplying air and sorbent through the nozzle to the duct such that the penetration of the sorbent into the duct is represented by the formula: Y=(Dₙa(pₙVₙ²/p_{f}V_{f}²)^{0.5}(x/Dₙ)^{0.33})/D_{f} where ‘Y’ is the fraction of duct penetration depth of the sorbent when the duct length is ‘x’, ‘Dₙ’ is the diameter of the nozzle, D_{f} is the depth of the duct, ‘pₙ’ and ‘p_{f}’ are the densities of the air supply and flue gas, respectively Vₙ′ and ‘V_{f}’ are the velocities of the air exiting the nozzle and the flue gas, respectively, and where ‘a’ is between 0.3 and 1.0 and where Y is between 0.3 and 0.8.

### CROSS REFERENCE TO RELATED APPLICATIONS

The present application is a national stage application under 35 U.S.C. § 371 of PCT/GB2016/052697 which claims priority to U.S. Provisional Application No. 62/212,190 filed Aug. 31, 2015 entitled INJECTION SYSTEM. The entirety of said aforementioned applications are hereby incorporated by reference into the present application.

### BACKGROUND

The present application relates generally to methods and systems for reducing acid gas and metal emissions from combustion systems and, more particularly, to injection systems and methods to reduce acid and metal emissions.

The listing or discussion of information or a prior-published document in this specification should not necessarily be taken as an acknowledgement that the information or document is part of the state of the art or is common general knowledge.

Combustion systems having boilers are known in the art and can include, for example, furnaces, pulverized coal plants, circulated fluidized beds, gas-fired systems, oil-fired systems, waste incinerators, direct-fired process heaters, kilns, tangentially-fired boilers, etc. Common elements of various combustion systems typically include a combustion chamber and a burner for igniting fuel located in the combustion chamber. Fuel (e.g. coal or biomass) is fed into the combustion chamber, where it is rapidly ignited and stabilized on burners. A number of undesirable components or pollutants may be included in the fuel, e.g. acid components or metal components, and enter the environment via the flue gas exiting the stack causing a number of undesirable consequences. Examples of undesirable acid components in the flue gas include sulfur dioxide (SO₂), sulfur trioxide (SO₃), sulfuric acid (H₂SO₄), hydrogen chloride (HCl), hydrogen bromide (HBr), hydrogen fluoride (HF), chlorine (Cl₂) and bromine (Br₂). Examples of undesirable metal components in the flue gas include antimony (Sb), arsenic (As), beryllium (Be), cadmium (Cd), chromium (Cr), cobalt (Co), lead (Pb), manganese (Mn), mercury (Hg), nickel (Ni), and selenium (Se). The current state of the art of dispersing or mixing solid sorbents into a flue gas for capture of acid gas and metal pollutants uses a plurality of injection lances.

Lance systems suffer from a number of problems. For example, lance systems may warp over time because of heat exposure, thereby promoting clogging, adversely affecting sorbent dispersion, increased maintenance costs and prohibiting removal of the lance for maintenance without a unit outage. Further, lance systems may overheat the sorbent, thereby clogging the lance or reducing sorbent utilization. In addition, lance systems may fail to properly distribute sorbent for desired efficacy.

When a greater percentage of captured pollutants is desired, additional lances are often added in attempt to distribute the sorbent across the cross-section of the flue gas duct. However, this strategy creates additional problems. For example, as the number of injection lances increase, evenly distributing the sorbent to multiple injection lances becomes mechanically complex. The sorbent is transported to the vicinity of the flue gas duct by a limited number of air streams, for example one or two air streams. In order to provide multiple injection lances, a single transport air stream must be evenly divided into multiple streams. Such division suffers from an inability to divide the sorbent stream evenly, and the number of division points increases the likelihood of plugging with the solid sorbent downstream of the division points. Also, as the number of injection lances increases, the total amount of transport air used increases in proportion to the number of lances because a certain minimum velocity of air must be maintained within each lance to minimize likelihood of plugging with the solid sorbent, for example, a minimum of 15 m/s. This increased air flow load requires that the transport pipe, air blowers and associated blower air conditioning equipment size must be increased.

Further to this, lance systems may result in undesirable flue gas pressure drops because of the depth of penetration of the lances and numbers of the lances.

In-duct mixing devices, such as baffle plates, can also be used in conjunction with lance injection systems to increase mixing of sorbent and flue gas. However, the application of in-duct mixing devices requires extended and unnecessary shutdown of the combustion unit for installation. Moreover, in-duct devices cause a significant and unnecessary gas pressure loss, which permanently increases operating cost. In-duct devices can also accumulate sorbent deposits or solids from the combustion system, thereby leading to shutdown of the combustion system for cleaning of the in-duct device.

These problems result in excessive or unnecessary maintenance, operational costs and offline requirements for combustion systems. These problems may also result in noncompliance with emissions regulations, and further increase costs and reduce power output.

Additionally, for lances to perform effectively for a desired duration, lances are almost always need to be placed in a vertical orientation to reduce additional warping caused by gravity. However, the vertical orientation of lance systems place unnecessary constraints on system design, access, maintenance, and efficacy.

The skilled person will appreciate that capture of undesired pollutants is directly related to the level of dispersion of the sorbent throughout the flue gas. The level of dispersion of the sorbent is in turn related to a number of factors that are often specific to the combustion system producing the pollutants. These factors include the diameter of the flue gas duct, the load of the furnace, the density of the flue gas and the velocity of the flue gas. The present application addresses these and other issues by provision of the following methods and systems described therein.

### SUMMARY

The present application relates to a method and injection system for treating flue gas in a duct with an injection system, the flue gas including an acid gas and/or one or more metal components. In an illustrative embodiment, the method and injection system includes at least one injection nozzle in communication with an air supply and supply of sorbent. The air and supply of sorbent is injected from the nozzle into a duct such that the penetration of sorbent into the duct is represented by the formula

Y=(Dₙa(pₙVₙ²/pᵣV_{f}²)^{0.5}(x/Dₙ)^{0.33})/D_{f}

where ‘Y’ is the fraction of duct penetration depth of the sorbent when the duct length is ‘x’, ‘Dₙ’ is the diameter of the nozzle, D_{f} is the depth of the duct, ‘pₙ’ and ‘p_{f}’ are the densities of the air supply and the flue gas, respectively, ‘Vₙ’ and ‘V_{f}’ are the velocities of the air exiting the nozzle and the flue gas, respectively, and where ‘a’ is between 0.3 and 1.0 and Y is maintained between 0.3 and 0.8.

In another embodiment, the application relates to an injection system having an injection nozzle in communication with an air supply and a supply of sorbent and the injection nozzle is fitted with a swirling device comprising a rotor having a plurality of radially extending fins angled such that the flow of air through the nozzle causes it to rotate as the flow of air and sorbent passes therethrough.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 shows a schematic drawing of example combustion system using a conventional lance injected system.

FIG. 2 shows a schematic drawing of a combustion system including injection system utilized in accordance with the present application.

FIG. 3 shows a schematic drawing of an injection system as utilized in accordance with the present invention.

FIG. 4 shows a perspective drawing of an injection system as utilized in accordance with the present invention.

FIGS. 5 to 8 show computer generated models of the dispersion of sorbent in cross sections of flue gas ducts in methods of the invention and the prior art;

FIG. 9 shows computer generated models of the dispersion of sorbent along the length of flue gas ducts in methods of the invention and the prior art;

FIG. 10 shows computer generated models of the concentration of pollutants along the length of flue gas ducts in methods of the invention and the prior art;

FIG. 11 shows dispersion of sorbent by prior art methods and method of the invention in a cross section of a duct.

### DETAILED DESCRIPTION OF ILLUSTRATIVE EMBODIMENTS

In the following description, like reference characters designate like or corresponding parts throughout the several views. Also in the following description, it is to be understood that such terms as “forward,” “rearward,” “left,” “right,” “upwardly,” “downwardly,” and the like are words of convenience and are not to be construed as limiting terms.

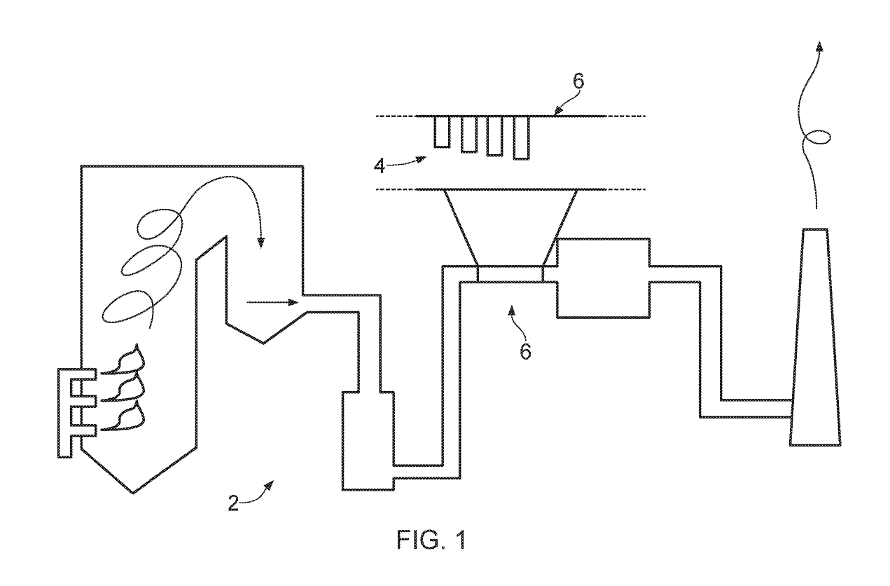

A conventional lance system 2 is shown in FIG. 1, where it can be seen that the injection lances 4 extend vertically into the duct 6 which forms the flue of a furnace for power generation. The lances 4 are used to inject a sorbent into the duct 6 to remove a portion of the pollutant materials from the flue gas produced by the furnace.

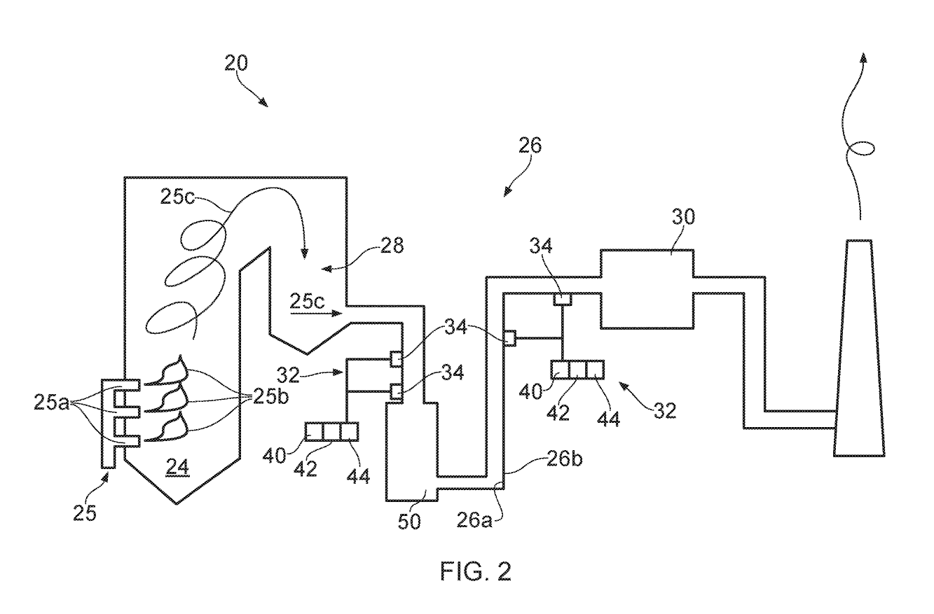

Many aspects of the present inventions relate generally to, inter alia, methods and systems for injecting into the ductwork of the combustion system. A combustion system 20 according to an embodiment of the invention is shown in FIG. 2.

In the system 20, the fuel 25 is fed to the burners 25a in the combustion chamber 24, which then produces the flames 25b and the flue gas 25c. The flue gas 25c may contain any number of acid components, e.g. SO₂, SO₃, H₂SO₄, HCl, HF, HBr, Cl₂, Br₂ and the like, and metal components, e.g. Hg, Se and the like.

The flue gas 25c travels through the duct 26, 26a, 26b downstream of a heat-transfer-to-water zone 28 and upstream of a particle capture device 30, e.g. upstream of at least one of an electrostatic precipitator and/or a gas scrubbing device.

As used herein, downstream from a heat-transfer-to-water zone 28 includes zones downstream from at least one of an economizer, a generating bank, a super heat bank, a reheat bank, a drum and a water wall. In many examples, downstream from a heat transfer-to-water zone will include the area downstream from the downstream-most of an economizer, a generating bank, a super heat bank, a reheat bank, a drum, and a water wall.

As used herein, upstream from a particle capture device 30 includes the area upstream from the flue gas entrance of at least one particle collection device, for example, upstream from at least one of an electrostatic precipitator or a gas scrubbing device that may also serve as a particulate capture device, for example a wet scrubber including spray tower scrubbers, spray-tray tower scrubbers, venturi scrubbers, etc. Accordingly, upstream from a particle collection device can also include, for example, an area upstream from a gas scrubbing device and downstream from an electrostatic precipitator.

The provision of a combustion system may vary from embodiment to embodiment. In some embodiments, providing includes constructing a combustion system. In other embodiments, providing includes locating a combustion system. In other embodiments, providing includes gaining access to a combustion system, e.g. for the purpose of installing a treatment system. In other embodiments, providing is achieved by operating a combustion system.

An embodiment of the invention therefore provides a method of generating electrical power with a turbine powered by a combustion system, the method comprising the supplying air and sorbent into a duct, using an injection system as described herein.

In an embodiment, the method includes the use of at least one injection system. FIG. 2 illustrates the use of an injection system 32 comprising injection nozzles 34 in communication with an air supply 40, a supply of sorbent 44 and a supply of transport air 42 to transport the sorbent.

The air and sorbent is supplied to the duct through the injection nozzles and into the duct such that the penetration of the sorbent into the duct is represented by the Formula 1:

Y=(Dₙa(pₙVₙ²/p_{f}V_{f}²)^{0.5}(x/Dₙ)^{0.33})/D_{f}

where ‘Y’ is the fraction of duct penetration depth of the sorbent when the duct length is ‘x’, ‘Dₙ’ is the diameter of the nozzle, D_{f} is the depth of the duct, ‘pₙ’ and ‘p_{f}’ are the densities of the air supply and the flue gas, respectively, ‘Vₙ’ and ‘V_{f}’ are the velocities of the air exiting the nozzle and the flue gas, respectively, and where ‘a’ is between 0.3 and 1.0 and Y is maintained between 0.3 and 0.8.

In an illustrative embodiment, a CPU (not shown) is provided to control the flow of air and/or sorbent through the injection nozzles to ensure that the Formula 1 is adhered to. The CPU receives data representative of the load under which the combustion system is operating and/or the velocity of the flue gas in the duct and may be programmed, for example upon installation or during maintenance to account for the diameters of the duct and nozzle.

The sorbent is therefore injected into the duct and effectively penetrates the flue gas passing through the duct. This results in a high level of sorbent dispersion and improved mixing with the undesired pollutants.

In an embodiment the injection nozzle 34 and/or the air supply 40 is equipped with a damper in order to adjust the pressure and/or velocity of the air transporting the sorbent and injected into the duct. In this way, the value of “pₙVₙ²” from the above formula can be altered depending on the system dimensions and conditions in order to achieve the optimal level of sorbent penetration into the flue gas. The damper is preferably controlled by the CPU.

In another embodiment, the load of the combustion system is increased or decreased by altering the quantity of fuel fed to the burners 25a, which in turn varies the value of ‘p_{f}V_{f}²’ from the above formula. The conditions can therefore be controlled in order to satisfy the Formula 1 and achieve the optimal level of sorbent penetration into the flue gas.

The air supply typically include at least one air mover. Air movers may vary from embodiment to embodiment. Typically the air movers may be configured to generate a mass flow of less than 6% (e.g. less than 3%) of the total flue gas mass flow. A suitable air mover, by way of example, includes a 480 VAC, less than 37.3 kW (less than 50 horsepower) blower. In many embodiments, air movers will be configured to generate an air flow velocity of about 150 m/s to about 15 m/s. Similarly, the application pressure of the high volumetric flow air may vary, for example in the range of 1 kPa (4 inches of water column (inWC)) to 12.45kPa (50 inWC).

In some examples, the air flow may also be humidified, e.g. may include any of entrained water droplets, mist, steam, etc. Humidification may be used, for example, to facilitate acid capture, e.g. the capture of halide acids.

Air movers may move ambient air, recirculated flue gas, or some combination thereof. Recirculated flue gas may be used, for example, to increase the temperature of the air supplied in an amount sufficient to promote calcination of the sorbent during or after transport, or during or after injection. It may also be used to reduce efficiency losses relative to using ambient air alone.

In terms of mass flow, the high volumetric flow air will typically be applied with a mass flow of less than 6% (e.g. less than 3%) of the total flue gas mass flow, wherein the 6% (e.g. less than 3%) is divided across the number of injection nozzles.

The transport air supply may include a compressor, blower, etc. selected or adjusted based on the desired sorbent application rate. For example, transport air will typically be applied in the range of 0.5 to 2 times the mass flow rate of the sorbent. In one example, where sorbent is applied at 10 tons/hour, transport air will be applied at 10 tons/hour. Exit velocities and pressures may also vary. For example, transport air velocity is typically mandated to exceed 15 m/s in order to maintain sorbent transport and to inhibit sorbent fallout.

Regarding the sorbent, in most examples, the sorbent will include solid particles, e.g. solid particles of at least one of calcium carbonate, calcium hydroxide, sodium sesquicarbonate, sodium bicarbonate, trona, nacholite, magnesium oxide, magnesium hydroxide, powdered activated carbon and the like. Other examples of suitable sorbents include other compounds capable of removing the undesired acid components or metal components previously mentioned. Sorbent particle size may vary. Typically, sorbent solid particles will have a median maximum length in the range of 0.5 μm to 100 μm. In another example, median maximum length will be in the range of 5 μm to 40 μm, or 10 μm to 15 μm.

The location of the injection systems may vary. For example, when combustion systems include an air heater 50, as shown in FIG. 2, the injection system may be injecting into an area of the duct having a flue gas temperature in the range of 288° C. to 454° C. (550° F. to 850° F.), and being located downstream of the heat-transfer-to-water zone 28 and upstream of the air heater 50. In another example of a combustion system having an air heater, application may be to an area of the ductwork having a flue gas temperature in the range of 121° C. to 232° C. (250° F. to 450° F.), and being located downstream of air heater (50) and upstream of the particle capture device 30. In some embodiments, e.g. when the injection system is downstream of an air heater, methods may additionally include heating the air supply to an amount sufficient to promote calcination of the sorbent during or after transport or during or after injection. Heating may be achieved using recycled flue gas, an inline heater, air heater exit air, preheated combustion air, etc. The amount of temperature increase may vary depending on the calcination temperature and the temperature of the air supply, e.g. increases in the range of 10° C. to 315° C. (50° F. to 600° F.) may be desired.

In some examples, combustion systems may not have an air heater. These examples may include injection of the air and sorbent into a duct having a flue gas temperature in the range of 121° C. to 454° C. (250° F. to 850° F.), and being downstream of a heat-transfer to-water zone and upstream of a particle capture device.

In other embodiments, the injection of the air and sorbent may take place at a position in or proximal to the heat-transfer-to-water zone 28 and/or, if present, one or more of the economizer, generating bank, super heat bank, reheat bank, drum and water wall. In such embodiments, the injection of the air and sorbent takes place at a position or positions where the temperature of the flue gas is 232° C. and 982° C. (between 450° F. and 1800° F.), for example between 454° C. and 982° C. (between 850° F. and 1800° F.). Injection of the air and sorbent at these high temperatures has been found to be particularly advantageous as it promotes the quicker absorption of, for example, SOx and/or Hg.

FIG. 3 illustrates an example of an injection device 70 according to the present invention. The device 70 includes a nozzle 74 for injecting the sorbent/air mixture into a duct. The nozzle 74 is in fluid communication, via a connector 73, with both a high velocity air supply line 72 and a sorbent supply line 71, the sorbent supply line providing sorbent and transport air for entraining and transporting the sorbent to the nozzle 74. The high velocity air supply line 72 is supplied by an air supply (not shown).

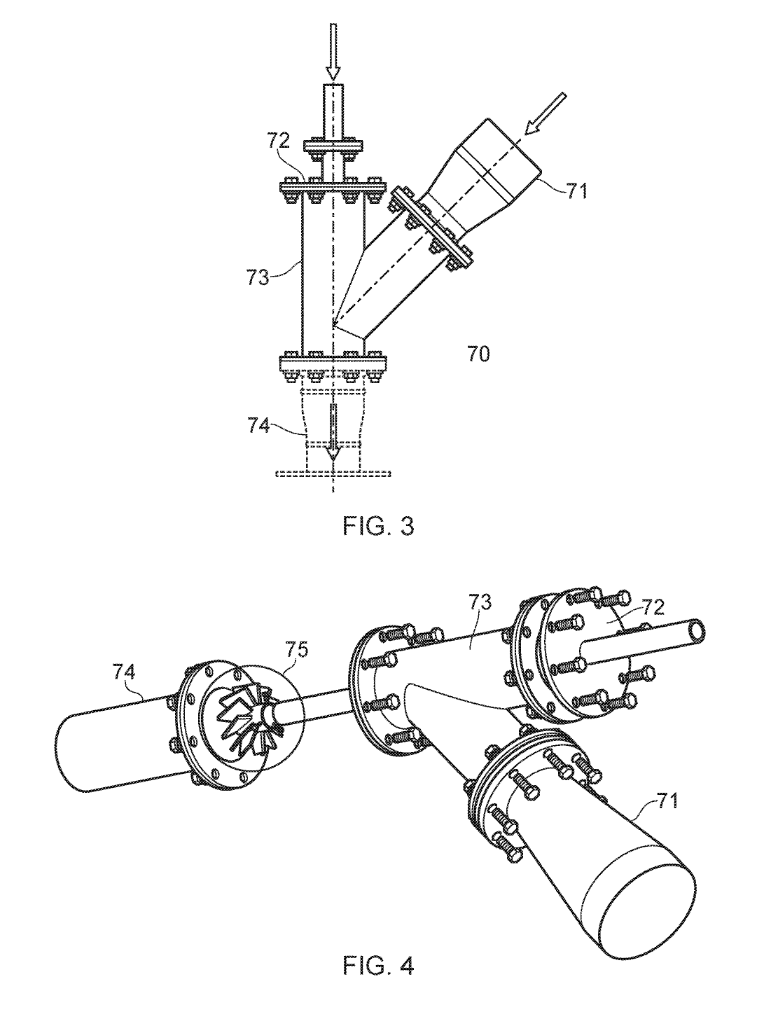

The device 70 is shown in more detail in FIG. 4 and is further fitted with a swirling device 5. The swirling device comprises a rotor having a plurality of radially extending fins angled such that the flow of air through the nozzle causes it to rotate in the manner of a turbine, deflecting the direction of flow of the air and sorbent as it passes there through. This action provides for an increased dispersion of the air and sorbent emitted from the nozzle in use and allows for the capture of a greater number of pollutants. Such an arrangement is particularly advantageous when the duct is small.

In one embodiment of the invention, the angle of the rotor fins of the swirler 75 is adjustable. For example, the fins may be off set at an angle of from 1 to 50° from the direction of the flow of the air and sorbent. This leads to a further degree of controllability in the system and permits the sorbent to be dispersed in a more localized area of the duct as is appropriate for the velocity of flue gas flowing through the duct and the dimensions of the duct.

Any humidifying water provided to the duct may be introduced through a suitably adapted injector 70, for example provided with a water line (not shown) into the connector 73 or where water vapor or droplets are entrained with the transport air and/or high velocity air supplies. In some embodiments, the water is provided to the duct through the use of one or more separate water injectors.

Numerous characteristics and advantages have been set forth in the foregoing description, together with details of structure and function. The present inventions, however, is illustrative only, and changes may be made in detail, especially in matters of shape, size, and arrangement of parts, within the principle of the present inventions.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges subsumed therein, and every number between the end points. For example, a stated range of “1 to 10” should be considered to include any and all subranges between (and inclusive of) the minimum value of 1 and the maximum value of 10; that is, all subranges beginning with a minimum value of 1 or more, e.g. 1 to 6.1, and ending with a maximum value of 10 or less, e.g. 5.5 to 10, as well as all ranges beginning and ending within the end points, e.g. 2 to 9, 3 to 8, 3 to 9, 4 to 7, and finally to each number 1, 2, 3, 4, 5, 6, 7, 8, 9 and 10 contained within the range.

It is further noted that, as used in this specification, the singular forms “a,” “an,” and “the” include plural referents unless expressly and unequivocally limited to one referent.

The invention will now be illustrated by the following non-limiting Examples.

### EXAMPLES

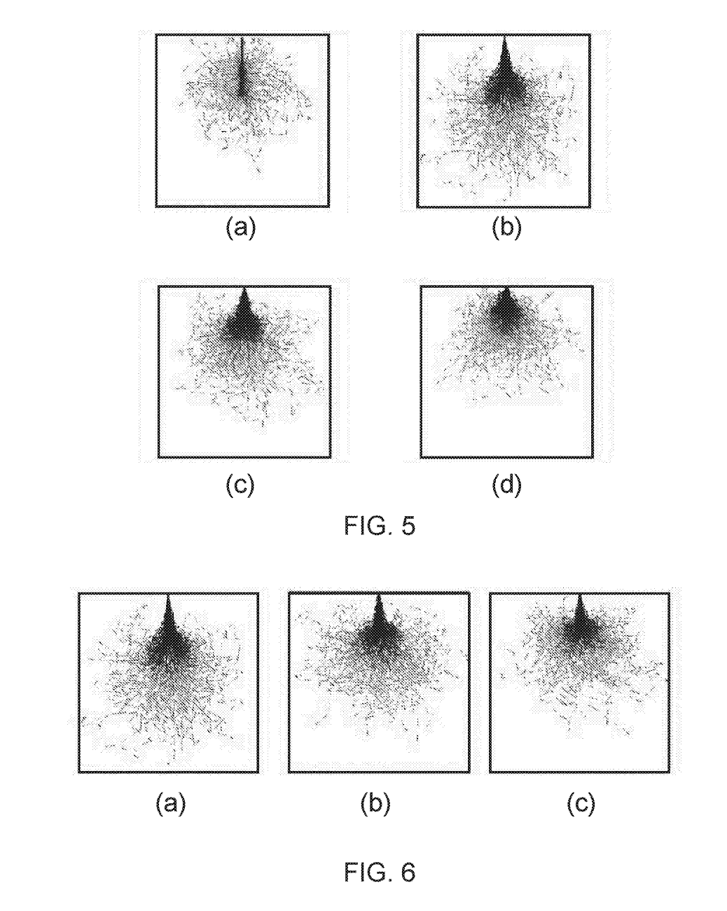

FIG. 5 demonstrates, via Computational Fluid Dynamics (CFD) modelling, the predicted dispersion of sorbent injection using an injection nozzle in a 6.01 m (20 ft) by 6.01 m (20 ft) flue gas duct. The conditions being equivalent to those present for 600 MW coal-fired boilers at full load with a flue gas velocity of 19 m/s. The nozzle diameter was 10.16 cm (4 inches) and the velocity of the injected air was 110 m/s.
FIG. 5 shows the dispersion of sorbent with:
FIG. 5(a)—Conventional injection lance;
FIG. 5(b)—injection nozzle;
FIG. 5(c)—injection nozzle with swirler having fins set to an angle of 30° to the direction of the flow of the injected gas;

FIG. 5(d)—injection nozzle with swirler having fins set to an angle of 45° to the direction of the flow of the injected gas.

The CFD modelling demonstrates that a significant improvement on chemical dispersion into the flue gas is made by the nozzle design in panel (b) against conventional lance injection in panel (a). The injection lances, typically shorter than 3.05 m (10 ft), have limited 30 penetration into flue gas duct, and the reagent cannot cover the center of the flue gas duct. With the injection system the sorbent has penetrated into the center of the flue gas duct, which results in higher reagent dispersion and coverage for better mixing with flue gas.

FIG. 5(c) and FIG. 5(d) show the sorbent dispersion when the freely rotatable set of fins are at an angle of 30° and 45°, respectively. As the angle of the fins increases, the air-boosted injection system has the ability to adjust the dispersion from center of the duct to the duct wall region. This feature increases the localized dispersion when the duct is small.

FIG. 6 demonstrates, via CFD modelling, the predicted dispersion of reagent injection using a 10.16 cm (4 in) injection nozzle in a 6.01 m (20 ft) by 6.01 m (20 ft) flue gas duct. The conditions being equivalent to those present for 600 MW coal-fired boilers at full load with a flue gas velocity of 19 m/s.
FIG. 6 shows the dispersion of sorbent with:
FIG. 6(a)—injection at 7.48 kPa (30 inwc) injection pressure, 110 m/s;
FIG. 6(b)—injection at 4.98 kPa (20 inwc) injection pressure, 90 m/s;
FIG. 6(c)—injection at 3.49 kPa (14 inwc) injection pressure, 75 m/s.

The different pressures shown in FIG. 6 can be achieved by adjusting the control damper. The varying injection pressures represent different air injection velocities, which in turn result in a difference in the penetration and dispersion of the sorbent into the flue gas duct. Dispersion and penetration can be adjusted and optimized by adjusting the damper position to control the air injection pressure.

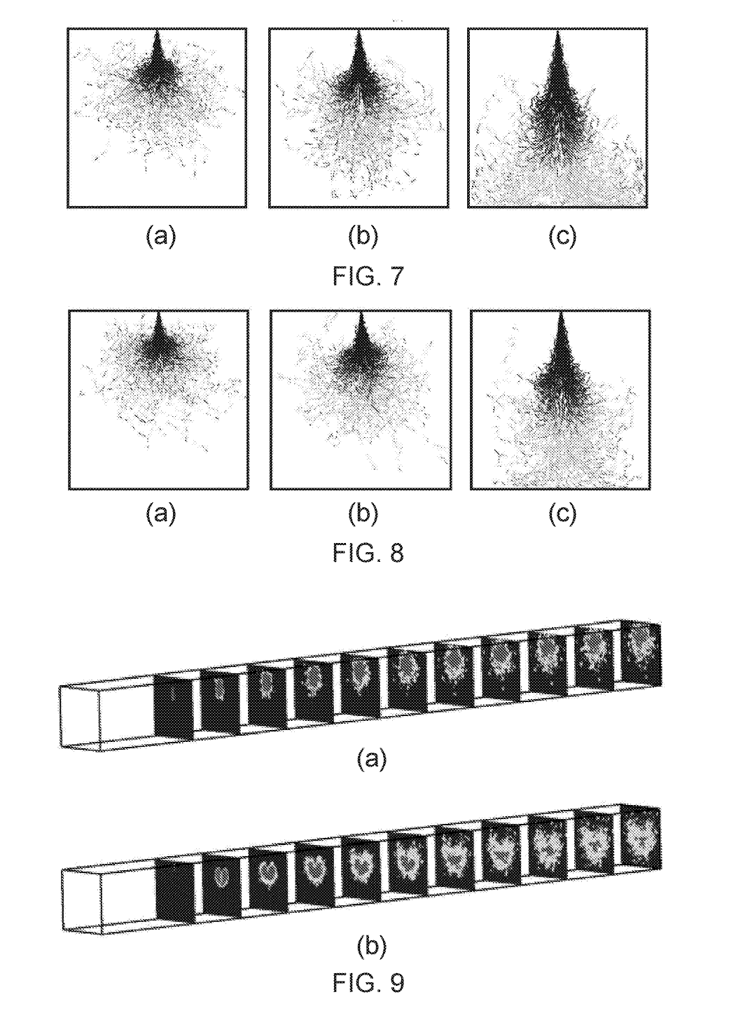

FIG. 7 demonstrates, via CFD modelling, the predicted dispersion of reagent injection using an injection nozzle in a 6.01 m (20 ft) by 6.01 m (20 ft) flue gas duct. The conditions being equivalent to those present for 600 MW coal-fired boilers with varying operating load. All have the same air injection pressure of 4.98 kPa (20 inwc) through a nozzle of 10.16 cm (4 in), providing an injection velocity of 90 m/s.
FIG. 7 shows the dispersion of sorbent with
FIG. 7(a)—19 m/s flue gas velocity at full load;
FIG. 7(b)—15 m/s flue gas velocity at 75% load;
FIG. 7(c)—10 m/s flue gas velocity at 50% load.

FIG. 8 demonstrates, via CFD modelling, the predicted dispersion of reagent injection using an injection nozzle in a 6.01 m (20 ft) by 6.01 m (20 ft) flue gas duct. The conditions being equivalent to those present for 600 MW coal-fired boilers with varying operating load. All have the same air injection pressure of 3.49 kPa (14 inwc) through a nozzle of 10.16 cm (4in), providing an injection velocity of 75 m/s.
FIG. 8 shows the dispersion of sorbent with
FIG. 8(a)—19 m/s flue gas velocity at full load;
FIG. 8(b)—15 m/s flue gas velocity at 75% load;
FIG. 8(c)—10 m/s flue gas velocity at 50% load.

FIGS. 7 and 8 show the CFD predicted penetration and dispersion with the injection nozzle pressure of 4.98 kPa (20 inwc) and 3.49 kPa (14 inwc), respectively, with varying flue gas velocity in the duct representing different boiler operating loads from 19 m/s at 100% load to 15 m/s at 75% load, to 10 m/s at 50% load. These predictions show that the penetration depth is a function of both air pressure or velocity and flue gas velocity. Table 1 summarizes the fraction of penetration depth Y as a function of these two operating parameters:

TABLE 1

| | | Air Pressure, kPa | | |
|---|---|---|---|---|
| | | (inwc) | | |
| | | 3.49 (14) | 4.98 (20) | 7.48 (30) |
| Velocity, m/s | 10 (50% load) | Y = 0.6; | Y = 0.65; | — |
| Flue Gas | | a = 0.55 | a = 0.5 | |
| | 15 (75% load) | Y = 0.4; | Y = 0.45; | — |
| | | a = 0.55 | a = 0.5 | |
| | 19 (100% load) | Y = 0.25; | Y = 0.35; | Y = 0.5; |
| | | a = 0.5 | a = 0.5 | a = 0.6 |

The different pressures can be achieved by adjusting the control damper position that has been added to the system. Different injection pressures represent different air injection velocities, which results in different penetration and dispersion in the flue gas duct (as evidenced by the data displayed in the Figures). Dispersion and penetration can be adjusted and optimized by adjusting the damper position to control the injection pressure of the air and sorbent.

From the above results, the penetration depth into the duct can be correlated with velocity of the air supply and flue gas cross flow by the following formula:

Y=(Dₙa(pₙVₙ²/p_{f}V_{f}²)^{0.5}(x/Dₙ)^{0.33})/D_{f}

where ‘Y’ is the fraction of duct penetration depth of the sorbent when the duct length is ‘x’, ‘Dₙ’ is the diameter of the nozzle, D_{f} is the depth of the duct, ‘pₙ’ and ‘p_{f}’ are the densities of the air supply and the flue gas, respectively, ‘Vₙ’ and ‘V_{f}’ are the velocities of the air exiting the nozzle and the flue gas, respectively, and where ‘a’ is between 0.3 and 1.0 and Y is maintained between 0.3 and 0.8 (for example during any fluctuation in the flow of flue gas).

FIG. 9 demonstrates, via CFD modelling, the predicted sorbent concentration at multiple cross sections in a 6.01 m (20 ft) by 6.01 m (20 ft) flue gas duct when the sorbent is injected into duct and mixed with flue gas at an air injection pressure of 7.48 kPa (30 inwc) through a nozzle of 10.16 cm (4 in), providing an injection velocity of 110 m/s using:
FIG. 9(a)—a conventional lance injection; and
FIG. 9(b)—an injection system.
   FIG. 9 shows that reagent concentration for conventional lance injection and an injection system. As mixing develops downstream of the flue gas duct the injection system exhibits quicker particle dispersion, which results in a larger coverage area by the sorbent than the lance system. Also, it can be seen that the injection system results in the sorbent cover area crossing the centerline of the duct, demonstrating the improved penetration capability by the system at injection pressure of 7.48 kPa (30 inwc).

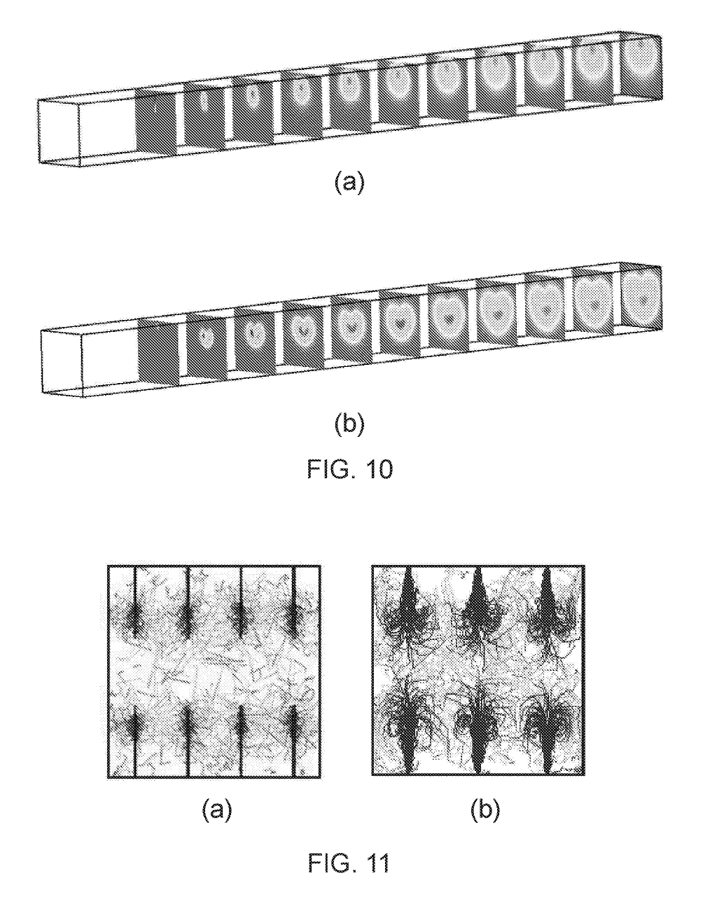

FIG. 10 demonstrates, via CFD modelling with detailed chemistry submodel, the predicted concentration of pollutants at multiple cross sections in a 6.01 m (20 ft) by 6.01 m (20 ft) flue gas duct, with the pollutants being removed by reagent injection at an air injection pressure of 7.48 kPa (30 inwc) through a nozzle of 10.16 cm (4 in), providing an injection velocity of 110 m/s using:
FIG. 10(a) a conventional lance injection; and
FIG. 10(b) an injection system.

FIG. 10 shows that the enhanced mixing and dispersion of reagent using an injection system results in increased pollutant removal at the same sorbent flow.

FIG. 11 demonstrates, via CFD modelling, the dispersion of sorbent in a 6.01 m (20 ft) by 6.01 m (20 ft) flue gas duct injection at an air injection pressure of 7.48 kPa (30 inwc) 25 through a nozzle of 10.16 cm (4 in), providing an injection velocity of 110 m/s using:
FIG. 11(a)—a full-designed conventional injection lances; and
FIG. 11(b)—a full designed air-boosted injection nozzle.

FIG. 11 demonstrates the improved penetration and dispersion by injection system similar to the single injection modelling shown in FIG. 5. This improved performance is achieved with fewer injection systems than conventional injection lances. This leads to reduced capital cost and complication of operation of the system.

Table 2 shows the comparison of sorbent concentration distribution and pollutant reduction between a conventional lance injection and the claimed injection system using a CFD based model, as in FIG. 9. The Root Mean Square (RMS) of reagent concentration at the duct exit is used to measure the uniformity of concentration, with a low RMS reflecting a more uniform concentration.

The model predicts an improved reagent concentration RMS from 87.4% to 47% when switching from a conventional lance injection to the injection system, suggesting significant improvement of both mixing and dispersion of sorbent. Consequently, the improved mixing leads to the increased pollutant reduction removal from 44.6% to 55.3% at the same reagent usage.

The last case in Table 2 demonstrates that the injection system and method of the present invention is able to achieve a 30% reduction on reagent usage and still achieve the same level of pollutant reduction compared to conventional lances.

TABLE 2
CFD predicted reagent distribution RMS
and pollutant removal efficiency at the
duct exit by chemistry submodels.

| | Reagent | |
|---|---|---|
| | Concentration | Pollutant |
| Configuration | RMS | Reduction |
| 8 Conventional Lances | 87.4% | 44.6% |
| 6 Air-Boosted | 47.3% | 55.3% |
| Injectors, at same | | |
| reagent usage | | |
| 6 Air-boosted | 47.0% | 44.1% |
| Injectors, at 30% | | |
| less reagent usage | | |

Preferences and options for a given aspect, feature or parameter of the invention should, unless the context indicates otherwise, be regarded as having been disclosed in combination with any and all preferences and options for all other aspects, features and parameters of the invention.

The present invention provides a method of treating flue gas in a duct with an injection system, the flue gas comprising an acid gas and/or one or more metal components, the injection system comprising at least one injection nozzle in communication with an air supply and a supply of sorbent; wherein the method comprises supplying air and sorbent through the nozzle to the duct, such that the penetration of the sorbent into the duct is represented by the Formula 1:

Y=(Dₙa(pₙVₙ²/p_{f}V_{f}²)^{0.5}(x/Dₙ)^{0.33})/D_{f}

where ‘Y’ is the fraction of duct penetration depth of the sorbent when the duct length is ‘x’, ‘Dₙ’ is the diameter of the nozzle, D_{f} is the depth of the duct, ‘pₙ’ and ‘p_{f}’ are the densities of the air supply and the flue gas, respectively, ‘Vₙ’ and ‘V_{f}’ are the velocities of the air exiting the nozzle and the flue gas, respectively, and where ‘a’ is between 0.3 and 1.0 and Y is maintained between 0.3 and 0.8 (for example 20 during any fluctuation in the flow of flue gas).

In an illustrative embodiments, ‘a’ is between 0.45 and 0.65, for example around 0.5 to 0.6.

As noted above, the level of dispersion of the sorbent throughout the flue gas is dependent on a number of factors. The inventors have surprisingly found that it is possible through the use of an injection system, as described above, to achieve controllable and improved penetration of sorbent into a duct comprising a flue gas. The depth of penetration of the air jet in the duct has been found to be important to the degree of mixing in the duct and the application of the Formula 1 provides a means for maintaining the penetration depth to an appropriate level, in turn providing efficiencies in sorbent usage.

It can be seen that the penetration depth of the sorbent can be correlated with both the velocity of the air exiting the nozzle(s) and the velocity of the flue gas cross flow and therefor use of the Formula 1 enables the operator to ensure that the penetration of the and mixing of the sorbent is both optimum and consistent throughout operation. This provides significant advantages in that the quantity of sorbent required to produce similar emission reduction is reduced compared to prior art systems, while also allowing for a smaller quantity of air to be provided through the nozzle, allowing the system to be operated at a lower power consumption.

For the avoidance of doubt and in contrast to the conventional lance systems, it is to be understood that the nozzle does not extend into the duct containing the flue gas.

In some embodiments, for example those in which the injector(s) are positioned on a single wall of the duct, Y is in the range 0.4 to 0.8, for example 0.5 to 0.7. This enables the efficient injection and mixing of the sorbent across the full depth of the duct. In other embodiments, for example where injectors are positioned on opposite walls of the duct, Y may be in the range 0.3 to 0.6, for example 0.4 to 0.5.

Preferably, the air supply from all the nozzles into the duct has a mass flow of less than 6% of the total flue gas mass flow, or less than 3% of the total gas mass flow or less than 2%. It is to be understood that the mass flow of the air supply (e.g. 2.8% of the total gas mass flow) is to be divided between the total number of injection systems employed in the claimed method.

The present invention further provides a method of treating flue gas in a duct with an injection system, the flue gas comprising an acid gas and/or one or more metal components, the system comprising at least one injection nozzle in communication with an air supply and a supply of sorbent for reducing the concentration of acid gas and/or metal components in the flue gas, wherein the method comprises supplying air and sorbent to the duct through the nozzle such that the air exiting the nozzle has a volumetric flow less than 56.63 m³/min (2000 ACFM), and/or wherein the air exiting all the nozzles has a mass flow of less than 3% of the total flue gas mass flow.

The velocity of the air and sorbent through the nozzle to the duct may be less than 150 m/s, preferably less than 110 m/s, or less than 95 m/s, or even less than 90 m/s.

The present invention therefore provides a method that, with a low flow rate and/or low velocity of the air and sorbent through the nozzle, leads to effective penetration of the sorbent in a flue gas duct.

The reduced quantity of sorbent required by the present invention means that that operating costs of treating the flue gas can be reduced by 5% to 50%. The reduced quantity of sorbent required also results in the reduction of transport system pluggage, power usage, ash removal and handling costs.

In some embodiments, the method includes adjusting the velocity and/or pressure of the air exiting the nozzle, for example to ensure compliance with the Formula 1. It is preferred that the adjustment is performed automatically, for example under the control of a 10 computer processing unit (CPU).

In an embodiment of the invention, the injection nozzle and/or the air supply comprises a damper to adjust the pressure and/or velocity of the air supplied to the duct through the nozzle. The damper may be controllable manually or automatically.

Preferably, the damper automatically adjusts the air supply, for example by means of the or a CPU, such that penetration of the sorbent into the duct is represented by the Formula 1:

Y=(Dₙa(pₙVₙ²/p_{f}V²)^{0.5}(x/Dₙ)^{0.33})/D_{f}

The damper therefore enables the penetration of the sorbent into the flue gas to be adjusted in view of the combustion system to satisfy the above formula, and therefore optimized for the best results.

In certain embodiments, the nozzle has a diameter in the range of 2.54 cm to 25.4 cm (1 inch to 10 inches), for example 7.62 cm to 15.24 cm (3 inches to 6 inches).

Advantageously, the air supply flow through each nozzle may be less than 42.48 m³/min (1500 Actual Cubic Feet per Minute, ACFM), or even 35.40 m³/min (1250 ACFM). The air supply to the nozzle may be humidified. Alternatively or additionally, the supply air may include recirculated flue gas.

The sorbent injected into the duct may interact either physically and/or chemically with at least a portion of the flue gas.

A solid or liquid sorbent may be used. The use of an injection system, as defined in the present invention, results in significant improvement to the dispersal of the sorbent (liquid or solid) into the flue gas in comparison to the conventional lance systems.

The sorbent may be a solid. Preferably, the sorbent is selected from hydrate lime, advanced hydrate lime, lime (calcium hydroxide), trona, sodium bicarbonate, sodium sesquicarbonate, activated carbon including halogenated (such as brominated) activated carbon, magnesium oxide, magnesium hydroxide, nacholite, calcium carbonate, and mixtures thereof, including slurries of these materials.

In certain embodiments, a solid sorbent may be injected with a water, for example in the form of steam or liquid droplets. Such injection of water may be used to increase the humidity of the flue gas in the region of the sorbent injection. The water may be co-injected with the sorbent by the injection system or may be injected by a separate water injection system.

Advantageously, the air supply is at a temperature suitable to calcinate the sorbent.

Alternatively, the sorbent is a liquid solution, or a combination of liquid and solid. Preferably, the liquid solution sorbent comprises salts and/or oxides (e.g. carbonate and/or bicarbonate salts) of sodium, potassium, magnesium, halogen-based mercury oxidizers, scruber additives or mixtures thereof, optionally together with further water (e.g. for humidification of the flue gas). Additional liquid chemical may include acetate of calcium, ammonium, citric acid, copper, zinc, cobalt, or mixtures thereof.

The use of humidifying hydrate lime, lime and trona to increase the capture of acid gas in flue gas has previously been unsuccessful due to the poor mixing of humidified droplets into the flue gas and the requirement for a longer vaporization time. These flaws have led to the formation of sorbent deposits that require the system to be shut down in order to remove.

The present invention addresses these deficiencies through the method of treating flue gas as described above, which disperses and mixes the humidified droplets with the flue gas quicker, preventing the formation of deposits. Further to this, the present method promotes localized mixing such that the sorbent becomes wet quicker, increasing the reactivity of the sorbent.

Preferably, the temperature of the flue gas is from 121° C. to 982° C., such as from 150° C. to 950° C., or from 155° C. to 900° C. The method of the present invention advantageously works over a greater temperature range compared to previously known systems. This is particularly advantageous for the use of hydrate lime as a sorbent which, without wishing to be bound by theory, absorbs pollutants such as SO₂ and SO₃ more effectively due to the absorption kinetics of the reagents involved.

Advantageously, the concentration of the acid gas and/or a metal component in the flue gas is reduced by a method of the invention. Preferably, the acid gas is one or more of SO₂, SO₃, H₂SO₄, HCl, HF, HBr, Cl₂ and Br₂. Preferably, the metal is selected from Hg, Se and mixtures thereof. Other metals which may be at least partially removed from the flue gas by the present method include Sb, As, Be, Cd, Cr, Co, Pb, Mn or Ni.

The sorbent may include a plurality of solid particles that are generally configured to reduce the concentration of the acid and/or metal component. Preferably, the sorbent is supplied to the nozzle by source of transport air.

In certain examples, the sorbent is supplied to the nozzle at a mass flow rate of X tons/hr and transport air is applied at a mass flow rate in the range of 0.5×X tons/hr to 2×X tons/hr and the transport velocity is more than 15 m/s. The sorbent solid particles may have a median maximum diameter in the range of 0.5 μm to 100 μm, preferably in the range of 5 μm to 40 μm, and more preferably in the range of 10 μm to 15 μm.

In an embodiment, the flue gas is produced by a combustion system. Preferably, the 25 combustion system powers a turbine, e.g. for the production of electricity.

The invention also provides a method of treating a flue gas in a duct, the flue gas comprising an acid gas and/or one or more metal components; wherein the duct is in fluid communication with an injection system, the injection system comprising an injection nozzle in communication with an air supply and a supply of sorbent; the method comprising reducing or increasing the velocity of flue gas; and optionally adjusting the velocity of the injected air and sorbent supplied through the injection nozzle to the duct, such that the penetration of the sorbent into the duct is represented by the formula:

Y=(Dₙa(pₙVₙ²/p_{f}V_{f}²)^{0.5}(x/Dₙ)^{0.33})/D_{f}

where ‘Y’ is the fraction of duct penetration depth of the sorbent when the duct length is ‘x’, ‘Dₙ’ is the diameter of the nozzle, D_{f} is the depth of the duct, ‘pₙ’ and ‘p_{f}’ are the densities of the air supply and the flue gas, respectively, ‘Vₙ’ and ‘V_{f}’ are the velocities of the air exiting the nozzle and the flue gas, respectively, and where ‘a’ is between 0.3 and 1.0 and Y is maintained between 0.3 and 0.8.

In some embodiments, the velocity of the flue gas is increased or decreased by increasing or decreasing the load of the combustion system, respectively.

Preferably, the flue gas is from a combustion system, e.g. a combustion system used for the generation of electrical power.

The present invention provides a method of generating electrical power with a turbine powered by a combustion system, wherein the combustion system generates a flue gas which exits the system through a duct, wherein the flue gas comprises an acid gas and/or one or more metal components and wherein the duct is in fluid communication with an injection system, the injection system comprising at least one injection nozzle in communication with an air supply and a supply of sorbent, the method comprising supplying air and sorbent into the duct through the nozzle such that the penetration of the sorbent into the duct is represented by the formula:

Y=(Dₙa(pₙVₙ²/p_{f}V_{f}²)^{0.5}(x/Dₙ)^{0.33})/D_{f}

where ‘Y’ is the fraction of duct penetration depth of the sorbent when the duct length is ‘x’, ‘Dₙ’ is the diameter of the nozzle, D_{f} is the depth of the duct, ‘pₙ’ and ‘p_{f}’ are the densities of the air supply and the flue gas, respectively, ‘Vₙ’ and ‘V_{f}’ are the velocities of the air exiting the nozzle and the flue gas, respectively, and where ‘a’ is between 0.3 and 1.0 and Y is maintained between 0.3 and 0.8.

Optionally, the method can further incorporate the use of a particle capture device and/or an air heater. The present invention also provides an injection system for a flue gas duct, the injection system comprising at least one injection nozzle in communication with an air supply and a supply of sorbent, the nozzle for the injection of air and sorbent into the duct, a control system (e.g. incorporating a CPU) to adjust the flow of air from the air supply and supply of sorbent such that the penetration of the sorbent into the duct is represented by the Formula 1:

Y=(Dₙa(pₙVₙ²/p_{f}V_{f}²)^{0.5}(x/Dₙ)^{0.33})/D_{f}

where ‘Y’ is the fraction of duct penetration depth of the sorbent when the duct length is ‘x’, ‘Dₙ’ is the diameter of the nozzle, D_{f} is the depth of the duct, ‘pₙ’ and ‘p_{f}’ are the densities of the air supply and the flue gas, respectively, ‘Vₙ’ and ‘V_{f}’ are the velocities of the air exiting the nozzle and the flue gas, respectively, and where ‘a’ is between 0.3 and 1.0 and Y is maintained between 0.3 and 0.8.

Preferably, the injection nozzle and/or air supply comprises a damper to adjust the pressure and/or velocity of the air supplied to the duct through the nozzle. The damper may be controllable manually or automatically, e.g. by means of a control unit.

Even more preferably, the damper automatically adjusts the velocity of the air supplied to the duct through the nozzle, such that penetration of the sorbent into the duct is represented by the Formula 1, as above:

Y=(Dₙa(pₙVₙ²/p_{f}V_{f}²)^{0.5}(x/Dₙ)^{0.33})/D_{f}

where ‘a’ is between 0.3 and 1.0 and Y is maintained between 0.3 and 0.8.

The damper therefore enables the penetration of the sorbent in to the flue gas to be adjusted and optimized for the best results. Advantageously, the sorbent is supplied to the nozzle by source of transport air.

The present invention also provides an injection system for a flue gas duct comprising: an injection nozzle in communication with an air supply and a supply of sorbent, the nozzle for injection of the sorbent into the duct, wherein the injection nozzle is fitted with a swirling device, which comprises a rotor having a plurality of radially extending fins angled such that the flow of air through the nozzle causes it to rotate as the flow of the air and sorbent passes there through.

Advantageously, the plurality of fins may be set at an angle of from 1° to 50° off set relative 30 to the direction of the air supply and sorbent supply.

Preferably, the injection nozzle and/or air supply comprises a damper to adjust the pressure and/or velocity of the air supplied to the duct through the nozzle. Advantageously, the sorbent may be supplied to the nozzle by source of transport air.

The addition of the rotatable set of fins to the injection system leads to, when in use, the formation of a rotating stream of air and sorbent injected into a duct. This increases the localised dispersion of the sorbent into the flue gas.

Further provided by the present invention is a software for controlling an injection system for a duct as defined herein, wherein the velocity of the air and sorbent through the injection nozzle to the duct, is adjusted such that penetration of the sorbent into the duct is represented by the Formula 1 (as defined above):

Y=(Dₙa(pₙVₙ²/p_{f}V_{f}²)^{0.5}(x/Dₙ)^{0.33})/D_{f}

where ‘a’ is between 0.3 and 1.0 and Y is maintained between 0.3 and 0.8.

Further provided by the present invention is a computer processing unit (CPU) configured (e.g. by appropriate software) to control an injection system for a duct as defined herein, wherein the velocity of the air and sorbent through the injection nozzle to the duct, is adjusted such that penetration of the sorbent into the duct is represented by the Formula 1 (as defined above):

Y=(Dₙa(pₙVₙ²/p_{f}V_{f}²)^{0.5}(x/Dₙ)^{0.33})/D_{f}

where ‘a’ is between 0.3 and 1.0 and Y is maintained between 0.3 and 0.8.

In illustrated embodiments, the software controls the or a damper fitted to the injection nozzle and/or air supply to adjust the pressure and/or velocity of the air supplied to the duct through the nozzle, to satisfy the above formula.

It can be seen that the methods and systems of the present invention provide:
(i)suitable mixing and penetration of sorbent into flue gas with injection at low velocities, total flow rate and/or mass flow (relative to total mass flow);
(ii) reduced energy and sorbent use, and/or increased pollutant capture relative to conventional systems, in turn reducing the operating costs by 5 to 50%;
(iii) a method for the treatment of flue gas operable at increased temperatures;
(iv) through the use of a rotatable attachment, increased and directable sorbent dispersion; and
(v) through the use of a damper, the ability to adjust and optimize the pressure and/or velocity of the air supplied to the duct through the nozzle to maximize sorbent dispersion

Although the present invention has been described with respect to illustrated embodiments, application is not limited to the specific embodiments shown and persons skilled in the art will recognize that changes may be made in form and detail without departing form the spirit and scope of the invention.

1. A method of treating flue gas in a duct with an injection system, the flue gas comprising an acid gas and/or one or more metal components, the injection system comprising at least one injection nozzle in communication with an air supply and a supply of sorbent; wherein the method comprises supplying air and sorbent through the nozzle to the duct, such that the penetration of the sorbent into the duct is represented by the formula:
Y=(Dₙa(pₙVₙ²/p_{f}V_{f}²)^{0.5}(x/Dₙ)^{0.33})/D_{f}
where ‘Y’ is the fraction of duct penetration depth of the sorbent when the duct length is ‘x’, ‘Dₙ’ is the diameter of the nozzle, D_{f} is the depth of the duct, ‘pₙ’ and ‘p_{f}’ are the densities of the air supply and the flue gas, respectively, ‘Vₙ’ and ‘Vᵣ’ are the velocities of the air exiting the nozzle and the flue gas, respectively, and where ‘a’ is between 0.3 and 1.0 and Y is maintained between 0.3 and 0.8.

2. The method according to claim 1, wherein the air supply has a mass flow of less than 6%, e.g. less than 3%, of the total flue gas mass flow.

3. (canceled)

4. The method of claim 1 comprising
adjusting at least one of the velocity and/or pressure of the air exiting the nozzle to control the penetration of sorbent in compliance with the Formula 1, wherein the adjustment is performed through control of a computer processing unit (CPU).

5. The method of claim 1 wherein at least one of the injection nozzle and the air supply comprises a damper to adjust the pressure and/or velocity of the air supplied to the duct through the nozzle.

6. (canceled)

7. (canceled)

8. The method of claim 1, wherein the air supply flow to the at least one nozzle is less than 42.48 m³/min (1500 ACFM).

9. The method of claim 1, wherein the velocity of the air and sorbent through the nozzle is less than 150 m/s.

10. (canceled)

12. (canceled)

13. (canceled)

14. (canceled)

15. (canceled)

16. The method of claim 1 wherein the sorbent is supplied to the nozzle by source of transport air.

17. The method of claim 1, further comprising injecting water into the duct in the form of liquid droplets or steam to humidify the air in the region of the injection of the sorbent.

18. (canceled)

19. (canceled)

20. (canceled)

21. (canceled)

22. (canceled)

23. An injection system for a flue gas duct the injection system comprising:
at least one injection nozzle in communication with an air supply and a supply of sorbent, the nozzle for the injection of air and sorbent into the duct, a control system to adjust the flow of air from the supply and supply of sorbent such that the penetration of the sorbent into the duct is represented by the formula:
Y=(Dₙa(pₙVₙ²/p_{f}V_{f}²)^{0.5}(x/Dₙ)^{0.33})/D_{f}
where ‘Y’ is the fraction of duct penetration depth of the sorbent when the duct length is ‘x’, ‘Dₙ’ is the diameter of the nozzle, D_{f} is the depth of the duct, ‘pₙ’ and ‘p_{f}’ are the densities of the air supply and the flue gas, respectively, ‘Vₙ’ and ‘V_{f}’ are the velocities of the air exiting the nozzle and the flue gas, respectively, and where ‘a’ is between 0.3 and 1.0 and where Y is between 0.3 and 0.8.

24. The injection system according to claim 23, wherein the at least one injection nozzle and the air supply comprises a damper to adjust the pressure and/or velocity of the air supplied to the duct through the nozzle.

25. (canceled)

26. (canceled)

27. The injection system according to claim 24 wherein the damper is controlled through a CPU.

28. (canceled)

29. The injection system according to claim 23, wherein the at least one nozzle comprises a swirling device, which comprises a rotor having a plurality of radially extending fins angled such that the flow of air through the nozzle causes it to rotate as the flow of the air and sorbent passes therethrough.

30. The injection system of claim 29, wherein the plurality of fins are set at an angle 25° to 50° offset relative to the direction of the air supply and sorbent supply.

31. The injection system of claim 30 wherein the angle at which the plurality of fins are offset relative the direction of flow of the air through the nozzle is adjustable.

32. An injection system for a flue gas duct comprising:
an injection nozzle in communication with an air supply and a supply of sorbent, wherein the injection nozzle is fitted with a swirling device to increase the angle of dispersion of the sorbent, the swirling device comprising a rotor having a plurality of radially extending fins angled such that the flow of air through the nozzle causes it to rotate as the flow of the air and sorbent passes therethrough.

33. The injection system of claim 32 wherein the injection nozzle comprises a damper to adjust the pressure and/or velocity of the air supplied to the duct through the nozzle.

34. The injection system of 32 wherein the sorbent is supplied to the nozzle by a source of transport air.

35. The injection system of claim 32, wherein the plurality of fins are set at an angle from 1° to 50° off set relative to the direction of the air supply and sorbent supply.

36. The injection system claim 32 wherein the angle at which the plurality of fins are offset relative the direction of flow of the air through the nozzle is adjustable either manually or automatically under the control of a control system such as a CPU.

37. (canceled)

38. (canceled)

39. The method according to claim 1, wherein the flue gas is from a combustion system for the generation of electrical power, and wherein the flue gas velocity is adjusted by changing the load of the combustion system.

40. (canceled)
